(19) United States
(12) Patent Application Publication
(10) Pub. No.: US 2026/0370355 A1
(43) Pub. Date: Nov. 19, 2026

(54) METHOD FOR MONITORING DISTORTIONS OF A RADIO SIGNAL, A RELATED RECEIVER AND A RELATED SYSTEM

(71) Applicant: THE EUROPEAN UNION, REPRESENTED BY THE EUROPEAN COMMISSION, Brussels (BE)

(72) Inventors: Francis Soualle, Haar (DE); Mariano Vergara, Lenggries (DE); Andre Waelkens, Munich (DE); Marc Boyer, Quint-Fonsegrives (FR); Philippe Brocard, Toulouse (FR); Ikhlas Selmi, Thalwil (CH); Paul Thevenon, Toulouse Cedex 4 (FR); Francisco Amarillo, Katwijk Aan Zee (NL)

(21) Appl. No.: 19/144,184

(22) PCT Filed: Dec. 22, 2023
(86) PCT No.: PCT/EP2023/087753

§ 371 Date: Jun. 27, 2025

(30) Foreign Application Priority Data
Dec. 27, 2022 (EP) 22216749.6

(51) Int. Cl. H04B 17/20

(52) U.S. Cl. CPC H04B 17/25

(57) ABSTRACT

A method, a related device and a related system for monitoring distortions of a received radio frequency signal in the chip domain, in a radio frequency system including a radio transmitter and a radio receiver, the method including receiving, by the radio receiver, the radio frequency signal from the radio transmitter, synchronizing, by the radio receiver, a replica radio frequency signal of the received radio signal to the received radio frequency signal to obtain a synchronized replica radio frequency signal, correlating, by the radio receiver, the received radio frequency signal and the synchronized replica radio frequency signal of the received radio signal, to obtain a first correlation function having a plurality of correlation function points, each correlation function point representing a differently delayed replica radio frequency signal, where the method further includes differentiating the first correlation function to obtain a chip domain observation.

### TECHNICAL FIELD

The present invention relates to a Method for monitoring distortions of a (GNSS) radio signal a related system and a related radio receiver.

### BACKGROUND ART

The monitoring and prompt detection of distortions in received GNSS radio signals further referred to as radio signals, which distortions may yield to an unacceptable bias of the Delay Lock Loop (DLL) tracking point, is especially important in Satellite Based Augmentation Systems (SBAS), such as the European EGNOS and the US WAAS systems offering integrity services. Such distortion perceived at the receiver may be caused by faults at signal transmission, and/or environmental effects such as multi-path reflections and interfering signals.

In operational Space Based Augmentation Systems such as EGNOS and WAAS, as well as their evolution, the conventional way to monitor radio signal distortions consists in using so-called Multi-Correlator GNSS receivers. A multi-correlator GNSS receiver differentiates with respect to conventional GNSS receivers by the introduction of additional correlators beside the Early-and Late correlators (typically used for the discriminator of Delay Lock Loop), and a prompt correlator (typically used for the Phase Lock Loop and data retrieval, navigation message demodulation). The number and positions of these additional correlators are Integrity-Service specific (dependent on the integrity and continuity requirements allotted to the signal distortion monitoring function). So-called Signal Quality Monitoring (SQM) metrics are generated by combining these correlator values.

Instead of monitoring the distortions in the “correlation domain”, an alternative technique is configured to monitor distortions of received radio frequency signals in the “chip domain”. This technique is also known as “Chip Domain Observation” (CDO). CDO can potentially provide better information on the signal distortion than “Correlation” observation, thus performing better as inputs for a detection process. However, this advantage comes at the cost of a complexity due to additional specific signal processing that has to be implemented in a dedicated GNSS radio receiver.

WO2005/060118 A1 discloses a method of detecting a spreading code of a received spread-spectrum signal, in particular a spreading code identifying a space vehicle of a GPS system.

The method comprises correlating the received spread-spectrum signal with a reference signal to detect the presence of one of a number of reference spreading codes. The correlating further comprises differentiating at least one of the received spread-spectrum signal, the reference signal, and the correlation signal, the correlating resulting in a differentiated correlation signal.

### DISCLOSURE OF THE INVENTION

An object of embodiments of the present invention is to provide a method and system for monitoring distortions of a received radio frequency signal in the Chip domain, of the above known type but wherein the monitoring of radio signal distortions in the Chip Domain can be performed without resorting to specialized and complex hardware receiver architectures, but rather to simple receiver architectures.

Accordingly, embodiments of the present invention relate to a method for monitoring distortions of a received radio frequency signal in the Chip domain, in a radio frequency system comprising a radio transmitter for transmitting said radio frequency signal and a radio receiver for receiving said radio frequency signal, said method comprising the step of:
receiving, by said radio receiver, said radio frequency signal from said radio transmitter; and
synchronizing, by said radio receiver, a replica radio frequency signal of said received radio signal to said received radio frequency signal to obtain a synchronized replica radio frequency signal; and
Correlating, by said radio receiver, said received radio frequency signal and said synchronized replica radio frequency signal of said received radio signal, to obtain a first correlation function, said first correlation function comprising a plurality of correlation function points, each correlation function point representing a differently delayed replica radio frequency signal, CHARACTERIZED IN THAT said method further comprises the steps of:
Differentiating said first correlation function obtained, to obtain a chip domain observation.

A subsequent embodiment of the present invention relates to a method for monitoring distortions of a received radio frequency signal in the chip domain according to claim 1, CHARACTERIZED IN THAT said step of Differentiating said first correlation function to obtain said chip domain observation is obtained by:

Calculating a difference between each correlation function point and its former subsequent correlation function point both belonging to said first correlation function.

Another embodiment of the present invention relates to a method for monitoring distortions of a received radio frequency signal in the chip domain according to claim 1, CHARACTERIZED IN THAT said step of Differentiating said first correlation function to obtain said chip domain observation is obtained by:

Offsetting, by said radio receiver, said replica radio frequency signal of said received radio signal to said received radio frequency signal over one sample period to obtain an offset synchronized replica radio frequency signal; and
generating, by said radio receiver, a second correlation function of said received radio frequency signal and said offset synchronized replica radio frequency signal, by correlating said received radio frequency signal with said offset synchronized replica radio frequency signal, said second correlation function comprising a plurality of correlation function points, each correlation function point representing a differently delayed replica radio frequency signal; and
Generating, by said receiver, said chip domain observation of said received signal by differentiating(subtracting) said second correlation function from said first correlation function.

Another embodiment of the present invention relates to a method for monitoring distortions of a received radio frequency signal in the Chip domain according to claim 1, CHARACTERIZED IN THAT said step of Differentiating, said first correlation function to obtain said chip domain observation is obtained by:
generating, by said radio receiver, a second synchronized correlation function by offsetting said first correlation function over one sample period in the correlation sample epoch; and
generating, by said radio receiver, said chip domain observation of said received signal by differentiating said second correlation function from said first correlation function.
   Still another embodiment of the present invention relates to a radio receiver (Rx) for monitoring distortions of a received radio frequency signal in the Chip domain at said radio receiver (Rx) of said radio frequency system, said radio frequency system further comprising a radio transmitter (Tx) for transmitting said radio frequency signal to said radio receiver, said Radio receiver comprising a:
a signal reception means (SRM), configured to receive, said radio frequency signal from said radio transmitter; and
a signal processing means (SPM) that is configured to:
synchronize a replica radio frequency signal of said received radio signal to said received radio frequency signal to obtain a synchronized replica radio frequency signal; and
correlate said received radio frequency signal and said synchronized replica radio frequency signal of said received radio signal, to obtain a first correlation function, said first correlation function comprising a plurality of correlation function points, each correlation function point representing a differently delayed replica radio frequency signal, CHARACTERIZED IN THAT said signal processing means (SPM) further is configured to:
differentiate said first correlation function to obtain a chip domain observation of said received radio frequency signal in the Chip domain.
   Another embodiment of the present invention relates to a Radio receiver (Rx) for monitoring distortions of a received radio frequency signal in the Chip domain according to claim 5, CHARACTERIZED IN THAT said signal processing means (SPM) further, to differentiate said first correlation function to obtain said chip domain observation, is configured to:
Calculate a difference between each correlation function point and its former correlation function point both belonging to the first correlation function

Another embodiment of the present invention relates to a Radio receiver (Rx) for monitoring distortions of a received radio frequency signal in the Chip domain according to claim 5, CHARACTERIZED IN THAT said signal processing means (SPM) further, to differentiate said first correlation function to obtain said chip domain observation, is configured to:
offset said replica radio frequency signal of said received radio signal to said received radio frequency signal over one sample period to obtain an offset synchronized replica radio frequency signal; and
correlate said received radio frequency signal with said offset synchronized replica radio frequency signal, to generate a second correlation function, said second correlation function comprising a plurality of correlation function points, each correlation function point representing a differently delayed replica radio frequency signal; and
differentiate said second correlation function from said first correlation function to generate said chip domain observation.

Another embodiment of the present invention relates to a radio receiver (Rx) for monitoring distortions of a received radio frequency signal in the Chip domain according to claim 5, CHARACTERIZED IN THAT said signal processing means (SPM) further, to differentiate a first correlation function to obtain said chip domain observation, is configured to:
generate, a second synchronized correlation function by offsetting said first correlation function over one sample period in the correlation sample epoch (domain); and
differentiate said second correlation function from said first correlation function to generate said chip domain observation.
   A further embodiment of the present invention relates to a Radio frequency System for monitoring distortions of a received (digital) radio frequency signal in the Chip domain at a radio receiver Rx of said radio frequency system, said radio frequency system further comprising a radio transmitter Tx for transmitting a radio frequency signal to said radio receiver, CHARACTERIZED IN THAT said Radio frequency System comprises a radio receiver according any of claims 5 to 8.

Indeed this objective is achieved by first synchronizing, a replica radio frequency signal of said received radio signal to said received radio frequency signal to obtain a synchronized replica radio frequency signal that is well in synchronization with the received radio frequency signal and subsequently correlating, by means of said receiver, said received radio frequency signal and said synchronized replica radio frequency signal of said received radio signal, to obtain a first correlation function where this first correlation function comprises a plurality of correlation function points, each correlation function point representing a differently delayed replica radio frequency signal and subsequently by differentiating said first correlation function obtained, a chip domain observation is obtained, where the chip domain observation belongs/corresponds to said received radio frequency signal in the Chip domain.

The synchronization of the replica radio frequency signal of said received radio signal to said received radio frequency signal can for instance be obtained by means of closed loop time delay estimation techniques such as a delay-locked loop DLL or combinations thereof with Phase locked loop PLL and/or frequency locked loop FLL estimation techniques.

The correlation of the received radio frequency signal and said synchronized replica radio frequency signal of said received radio signal, to obtain a first correlation function may be performed by means of a multi-correlator.

The “prompt” correlator stays on the peak of the correlation function, hence obtaining synchronization and based on the synchronization value, the plurality of additional correlators is employed, whether delayed or advanced with respect to the prompt correlator, by whatever spacing, it does not have to be an integer number of samples, to obtain the other values of the correlation function, needed for using the method.

The step of generating a differentiated first correlation function can be obtained by selecting a point in the correlation function, which correlation function is composed of a plurality of subsequent correlation function points, and subtracting its value from the next neighbor to the right, which provides the first bin of the Chip Domain Observation. Proceeding likewise with the mentioned neighbor and its subsequent neighbor to the right one obtains the second CDO bin and so forth. This sequence is repeated until the final correlation function point of the correlation function is reached.

In an embodiment of the present invention, the step of generating a differentiated first correlation function can be obtained by calculating a difference between each correlation function point and its former subsequent correlation function point both belonging to said first correlation function. Hereto, a point in the first correlation function is selected, which correlation function is composed of a plurality of subsequent correlation function points, and subtracting its value from the next neighboring correlation function points to the right, which provides the first bin of the CDO. Proceeding likewise with the mentioned neighbor and its subsequent neighbor to the right one obtains the second CDO bin and so forth. This sequence is repeated until the final correlation function point of the correlation function is reached.

A further embodiment of the present invention relates to a method for monitoring distortions of a received radio frequency signal in the chip domain wherein said step of generating a differentiated first correlation function to obtain said chip domain observation is obtained by first offsetting, by means of said receiver, said replica radio frequency signal of said received radio signal, relative to said received radio frequency signal, over one sample period to obtain an offset synchronized replica radio frequency signal and subsequently by generating, by means of said receiver, a second correlation function of said received radio frequency signal and said offset synchronized replica radio frequency signal, by correlating said received radio frequency signal with said offset synchronized replica radio frequency signal.

The meant correlation function comprises a plurality of correlation function points wherein each correlation function point represents a differently delayed replica radio frequency signal and further generating said chip domain observation CDO of said received signal by differentiating, i.e., by subtracting said second correlation function from said first correlation function.

The “prompt” correlator stays on the peak of the correlation function, hence obtaining synchronization and based on this synchronization value, the plurality of additional correlators can be employed (either delayed or advanced with respect to the prompt correlator, by whatever spacing, considering that in this alternative embodiment the spacing has to be an integer number of samples to obtain the other values of the correlation function, needed for using the method.

An alternative embodiment of the present invention relates to a method for monitoring distortions of a received radio frequency signal in the Chip domain wherein said step of generating a differentiated first correlation function to obtain said chip domain observation is obtained by first generating, by said receiver, a second synchronized correlation function by delaying or offsetting said first correlation function over one sample period in the correlation sample epoch (domain) and by subsequently generating, by said receiver, said chip domain observation of said received signal by differentiating, i.e. subtracting said second correlation function from said first correlation function.

### BRIEF DESCRIPTION OF THE DRAWINGS

The above and other objects and features of the invention will become more apparent and the invention itself will be best understood by referring to the following description of an embodiment taken in conjunction with the accompanying drawings wherein:

FIG. 1 represents a system for monitoring distortions of a received radio frequency signal in the Chip domain at a radio receiver Rx of said radio frequency system;

FIG. 2 represents the functional elements of the radio transmitter TX and a radio receiver RX according to embodiments of the present invention.

FIG. 3 represents the construction of the chip domain observation by correlating the incoming signal with the derivative of the local replica; and

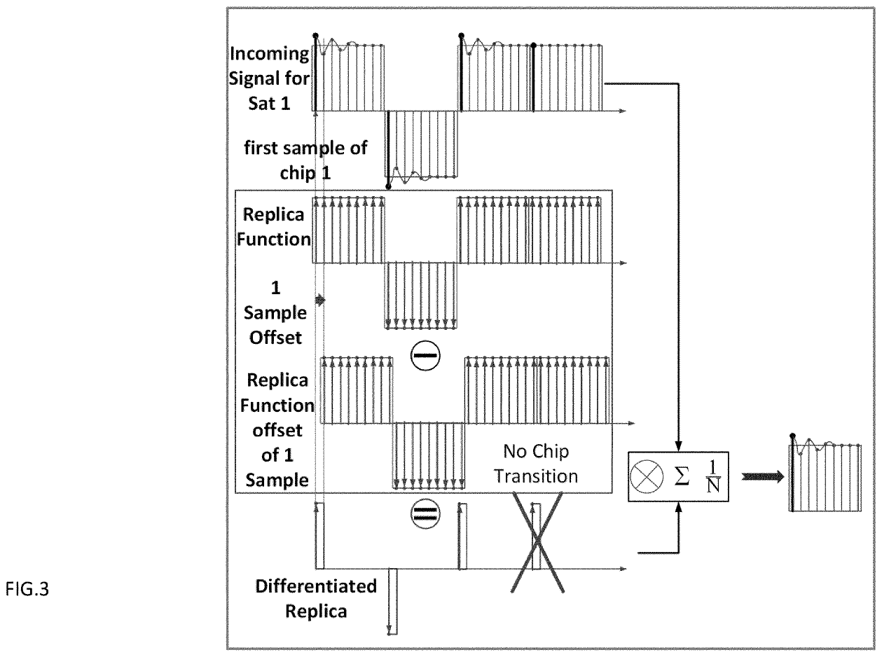

FIG. 4 illustrates the construction of the chip domain observation by differentiating the Replica before multiplication with incoming signal; and

FIG. 5 illustrates a construction of the chip domain observation by differentiating the correlation function, in accordance with an embodiment of the present invention

### MODES FOR CARRYING OUT THE INVENTION

The description and drawings merely illustrate the principles of the invention. It will thus be appreciated that those skilled in the art will be able to devise various arrangements that, although not explicitly described or shown herein, embody the principles of the invention and are included. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. This means that there exists a path between an output of A and an input of B which may be a path including other devices or means.

It is to be noted that the described functional means of the system may be distributed over the first communications device and/or one or more further network elements such as a server device as described in the further appended claims.

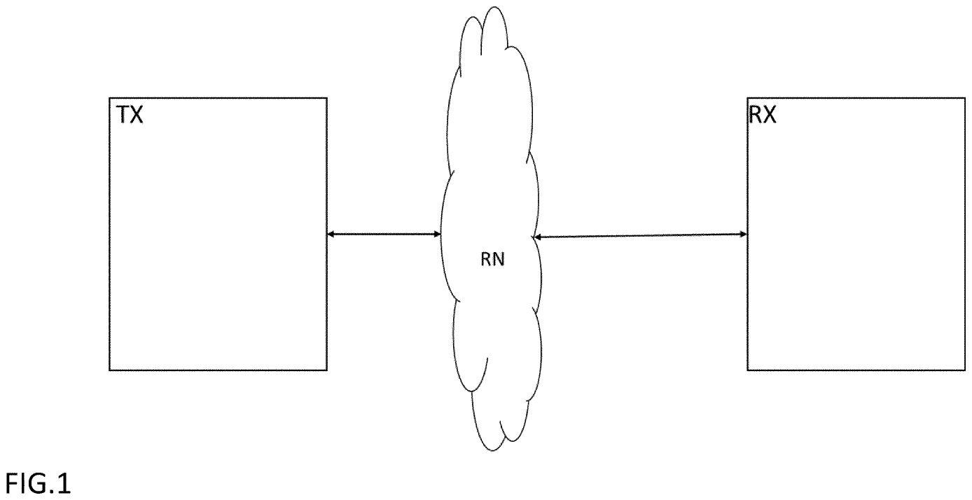

In the following paragraphs, referring to the drawing in FIG. 1, an implementation of the Radio frequency System for monitoring distortions of a received radio frequency signal in the Chip domain at a radio receiver Rx of said radio frequency system is described.

In a further paragraph, all connections between mentioned elements are defined.

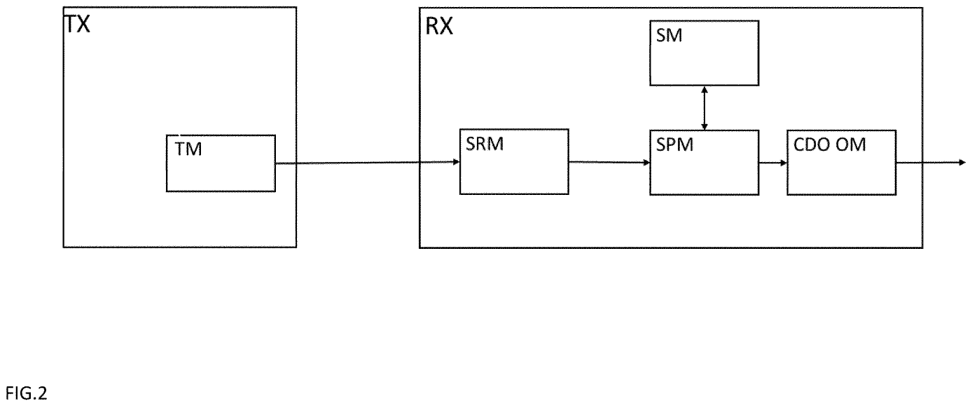

Subsequently all relevant functional means of the Radio Transmitter Tx and Radio Receiver RX as presented in FIG. 2 are described followed by a description of all interconnections.

In the succeeding paragraph the actual execution of the system is described.

The radio frequency system comprises a radio transmitter Tx for transmitting a radio frequency signal to said radio receiver configured to receive said radio frequency signal.

It is to be noted that although only one radio transceiver Tx and only one radio receiver Rx is disclosed for clarity reasons, the system according to the present invention may comprise a plurality of radio transmitters and respective radio receivers.

The radio navigation system according to embodiments of the present invention may be a satellite radio navigation system such as the Global Navigation satellite system GNSS or a single positioning beacon such as a Pseudo-Lite or a network of positioning beacons or be a terrestrial system such as wireless communication network requesting synchronizations to the User Terminal.

Such radio transmitter Tx may be a GNSS transmitter being a Satellite transmitting Radio Navigation Signals, a Satellite part of a satellite communication network, a Pseudo-Lite, or a transmitting equipment implemented in terrestrial communication networks, such as a Base Transceiver Station (BTS), a Fixed or Mobile radio Transmitter in case of a wireless communication network, or a device implemented in a V2V or V2X communication network.

A second essential element of the system Radio frequency System for monitoring distortions of a received radio frequency signal is a Radio Receiver RX of a user, where the radio receiver Rx is configured to receive the radio frequency signal transmitted by a radio transmitter Tx of the radio navigation system according to embodiments of the present invention. Such radio receiver may be a GNSS receiver being implemented by any kind of radio receiver.

Such a radio receiver may be a GNSS receiver being incorporated in a user device such as a navigation device or a personal mobile device like a smartphone, being a device comprising a processor with coupled memory and interfacing means like a display and a keyboard.

Such a mobile computing device is configured to install a multiplicity of different kinds of applications where the execution of each such application is meant for performing a different kind of task, such as navigation.

Alternatively, embodiments of such radio receivers may comprise (Hardware) receivers dedicated for the monitoring of Evil Waveform and implemented in the ground-segment of SBAS (e.g., EGNOS, WAAS) or receivers such as Software Defined Radio (SDR) receivers in which case the application of embodiments of the present is applicable to end-users for evaluating locally the signal quality (User-based Integrity Monitoring).

A first essential element of the radio transmitter TX is a transmitting means TM that is configured to transmit a radio signal to said radio receiver over the radio network RN. The transmitted radio signal may be any GNNS radio signal which can be processed using only one spectral lobe, such as GPS C/A L1 transmitted in the L1 Band or GLONASS C/A code. This also applies to other GNSS signals that might have more than one spectral lobe (typically two), but can be processed considering only one, such as Galileo E1 or Beidou B1 signals, which have two spectral lobes, but are often tracked in so called single side-band tracking focusing on only one of the lobes.

Such radio frequency signal may for example apply a waveform modulation such as a Binary Phase Shift Keying (BPSK) as for the GPS C/A signal, or a Binary Offset Carrier (BOC) as for the Galileo E1-B/-C or GPS L1C.

Essential elements of the Radio receiver Rx for monitoring distortions of a received radio frequency signal in the Chip domain are the signal reception means SRM that is configured to receive said radio frequency signal from said radio transmitter Tx and a signal processing means SPM that is configured to:
synchronize a replica radio frequency signal of said received radio signal to said received radio frequency signal to obtain a synchronized replica radio frequency signal; and
correlate said received radio frequency signal and said synchronized replica radio frequency signal of said received radio signal, to obtain a first correlation function, said first correlation function comprising a plurality of correlation function points, each correlation function point representing a differently delayed replica radio frequency signal,
Generate said first correlation function to obtain a chip domain observation of said received radio frequency signal in the Chip domain.

Such signal processing means SPM may comprise a micro-processor for, amongst others, processing the signal to be transmitted and the processing means further may comprise a memory device, coupled to said microprocessor, for storing electronic information such as computer instructions, results of the signal processing including final and intermediate results and further information.

The Radio receiver Rx further comprises a storage means SM being an internal memory SM for storing programs, intermediate results and final results of the actual execution of the method for monitoring distortions of a received radio signal.

A second relevant functionality of the storage means SM may be storing the software application for monitoring distortions of a received radio signal. The storage means SM is configured to store at least one further application for being executed by the computer processing means CPM. Such a memory SM may be a local computing memory device but alternatively may be an external computing memory and optionally a distributed external computing memory.

In a first embodiment, the signal processing means SPM in order to differentiate the first correlation function to obtain said chip domain observation, is configured to first select a point in the correlation function, which correlation function is composed of a plurality of correlation function points, and subtracting its value from the next neighboring correlation function point to the right, which provides the first bin of the CDO. Proceeding likewise with the mentioned neighbor and its subsequent neighbor to the right one obtains the second CDO bin and so forth. This sequence is repeated until the final correlation function point of the correlation function is reached resulting in a corresponding CDO.

In an alternative embodiment, the signal processing means SPM further in order to differentiate said first correlation function to obtain said chip domain observation, is configured to:
offset said replica radio frequency signal of said received radio signal to said received radio frequency signal over one sample period to obtain an offset synchronized replica radio frequency signal; and
correlate said received radio frequency signal with said offset synchronized replica radio frequency signal, to generate a second correlation function, said second correlation function comprising a plurality of correlation function points, each correlation function point representing a differently delayed replica radio frequency signal; and
differentiate said second correlation function from said first correlation function to generate said chip domain observation.
In still another alternative embodiment, the signal processing means SPM further, to differentiate a first correlation function to obtain said chip domain observation, is configured to:
   generate, a second synchronized correlation function by offsetting said first correlation function over one sample period in the correlation sample epoch; and
   differentiate said second correlation function from said first correlation function to generate said chip domain observation.

The transmitting means TM is coupled over a wireless transmission path to the reception means RM of the radio receiver Rx.

The reception means RM of the radio receiver further is coupled to the signal processing means SPM may that in turn is coupled to the CDO output means CDO_OM.

Further, the signal processing means SPM is coupled to the Storage means SM.

In the succeeding paragraph the actual implementation of a system for monitoring distortions of a received radio frequency signal in the Chip domain, according to an embodiment of the present invention is described.

In order to explain an embodiment of the present invention it is assumed that the meant radio transmitter Tx transmits a radio frequency signal such as GNSS signal modulated with a BPSK waveform, as the current GPS C/A signals transmitted in the L1 Band is towards the radio receiver Rx.

Alternatively, signals which can be processed using only one spectral lobe such as Galileo E1 signals or Beidou B1 signals, which have two spectral lobes, however often as single spectral lobe is used for e.g. tracking. In other words, any signal that can be processed by using a single side lobe, which is more or less all of GNSS may be applicable and relevant in embodiment according to the present invention.

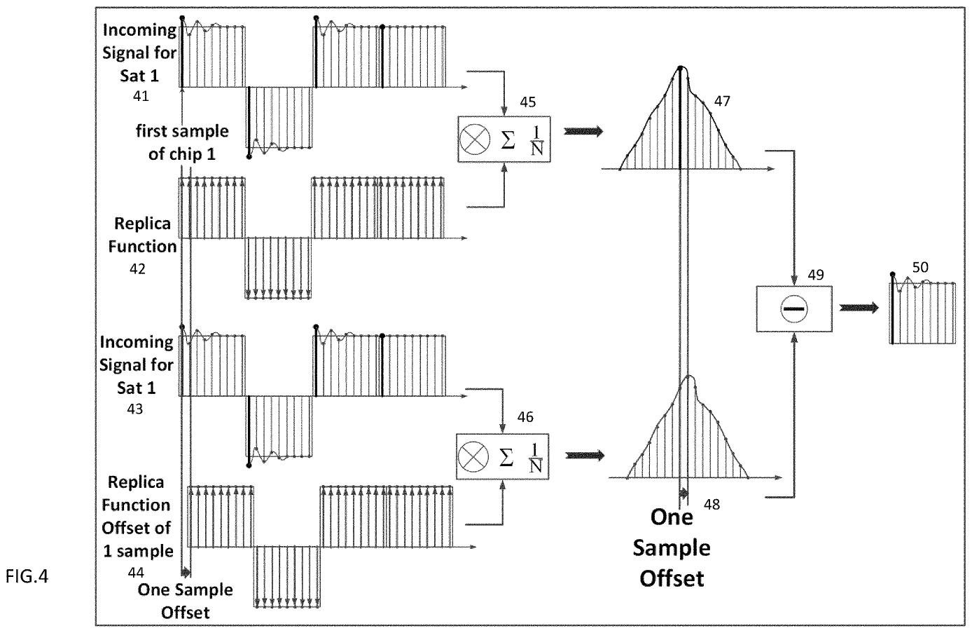

The signal reception means SRM of the radio receiver Rx subsequently receives this transmitted GNSS signal modulated with a BPSK waveform, as the current GPS C/A signals transmitted in the L1 Band 41 from said radio transmitter Tx as is shown in FIG. 4.

The signal processing means SPM, at reception of the meant GNSS signal synchronizes, as shown in FIG. 4, a replica radio frequency signal of said received radio signal to said received radio frequency signal 41 to obtain a synchronized replica radio frequency signal 42 and subsequently, as shown in FIG. 4, performs the correlation 45 of said received radio frequency signal and said synchronized replica radio frequency signal of said received radio signal in order to obtain a first correlation function 47 where this first correlation function comprises a plurality of correlation function points, each correlation function point representing a differently delayed replica radio frequency signal as shown in FIG. 4.

Finally, by means of the signal processing means SPM that further differentiates a first correlation function 47 to obtain the chip domain observation of said received radio frequency signal in the Chip domain.

In an embodiment of the present invention, the step of generating a differentiated first correlation function to obtain said chip domain observation, can be performed by calculating a difference between each correlation function point and its former subsequent correlation function point both belonging to said first correlation function. Hereto, a point in the first correlation function is selected, which correlation function is composed of a plurality of subsequent correlation function points, and subtracting its value from the next neighboring correlation function points to the right, which provides the first bin of the CDO. Proceeding likewise with the mentioned neighbor and its subsequent neighbor to the right one obtains the second CDO bin and so forth. This sequence is repeated until the final correlation function point of the correlation function is reached.

In an advantageous embodiment of the present invention, as shown in FIG. 4, the signal processing means SPM further, in order to differentiate said first correlation function to obtain said chip domain observation, offsets said replica radio frequency signal of said received radio signal to said received radio frequency signal over one single sample period to obtain an offset synchronized replica radio frequency signal (see 44, FIG. 4) and subsequently correlates 46 said received radio frequency signal with said offset synchronized replica radio frequency signal to generate a second correlation function signal, see 48, FIG. 4, where the said second correlation function comprises a plurality of correlation function points. Each such correlation function point represents a differently delayed replica radio frequency signal. Finally, the signal processing means SPM differentiates said second correlation function from said first correlation function signal (see 49 FIG. 4, in order to generate said chip domain observation 50 by subtracting 49 the said second correlation function from said first correlation function.

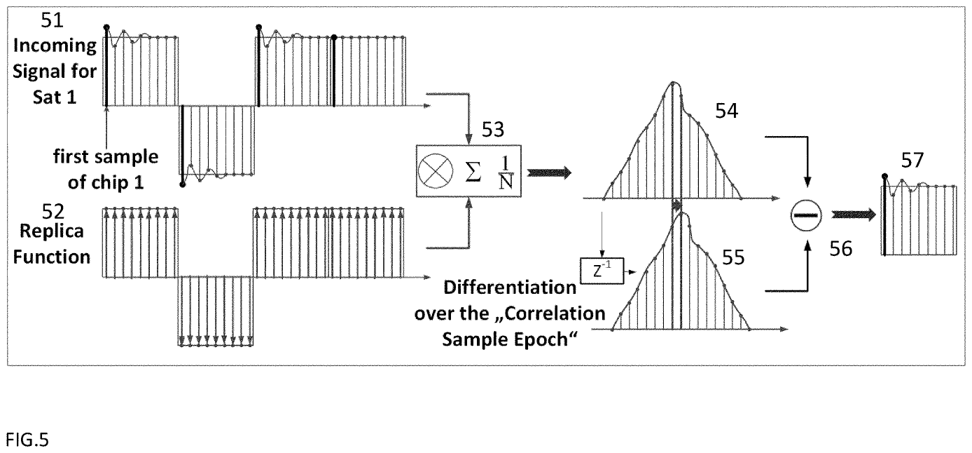

In an alternative advantageous embodiment of the present invention as shown in FIG. 5, the signal processing means SPM alternatively, in order to differentiate a first correlation function to obtain said chip domain observation, generates, a second synchronized correlation function by offsetting said first correlation function over one single sample period in the correlation sample epoch (domain) 55 and finally differentiates 56 said second correlation function from said first correlation function to generate said chip domain observation 57 by subtracting 56 the said second correlation function from said first correlation function.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

1. Method for monitoring distortions of a received radio frequency signal in the Chip domain, in a radio frequency system comprising a radio transmitter for transmitting said radio frequency signal and a radio receiver for receiving said radio frequency signal, said method comprising:
receiving, by said radio receiver, said radio frequency signal from said radio transmitter;
synchronizing, by said radio receiver, a replica radio frequency signal of said received radio signal to said received radio frequency signal to obtain a synchronized replica radio frequency signal;
correlating, by said radio receiver, said received radio frequency signal and said synchronized replica radio frequency signal of said received radio signal, to obtain a first correlation function, said first correlation function comprising a plurality of correlation function points, each correlation function point representing a differently delayed replica radio frequency signal,
differentiating said first correlation function obtained, to obtain a chip domain observation, and
generating, by said radio receiver, said chip domain observation based on said step of differentiating said first correlation function.

2. Method for monitoring distortions of a received radio frequency signal in the chip domain according to claim 1, wherein said step of differentiating said first correlation function to obtain said chip domain observation is obtained by:
calculating a difference between each correlation function point and its former subsequent correlation function point both belonging to said first correlation function.

3. Method for monitoring distortions of a received radio frequency signal in the chip domain according to claim 1, wherein said step of Differentiating said first correlation function to obtain said chip domain observation is obtained by:
offsetting, by said radio receiver, said replica radio frequency signal of said received radio signal to said received radio frequency signal over one sample period to obtain an offset synchronized replica radio frequency signal;
generating, by said radio receiver, a second correlation function of said received radio frequency signal and said offset synchronized replica radio frequency signal, by correlating said received radio frequency signal with said offset synchronized replica radio frequency signal, said second correlation function comprising a plurality of correlation function points, each correlation function point representing a differently delayed replica radio frequency signal; and
generating, by said receiver, said chip domain observation of said received signal by differentiating(subtracting) said second correlation function from said first correlation function.

4. Method for monitoring distortions of a received radio frequency signal in the Chip domain according to claim 1, wherein said step of differentiating, said first correlation function to obtain said chip domain observation is obtained by:
generating, by said radio receiver, a second synchronized correlation function by offsetting said first correlation function over one sample period in the correlation sample epoch; and
generating, by said radio receiver, said chip domain observation of said received signal by differentiating said second correlation function from said first correlation function.

5. Radio receiver (Rx) for monitoring distortions of a received radio frequency signal in the Chip domain at said radio receiver (Rx) of said radio frequency system, said radio frequency system further comprising a radio transmitter (Tx) for transmitting said radio frequency signal to said radio receiver, said Radio receiver comprising a:
a signal reception means (SRM), configured to receive, said radio frequency signal from said radio transmitter;
a signal processing means (SPM) that is configured to:
synchronize a replica radio frequency signal of said received radio signal to said received radio frequency signal to obtain a synchronized replica radio frequency signal; and
correlate said received radio frequency signal and said synchronized replica radio frequency signal of said received radio signal, to obtain a first correlation function, said first correlation function comprising a plurality of correlation function points, each correlation function point representing a differently delayed replica radio frequency signal,
differentiate said first correlation function to obtain a chip domain observation of said received radio frequency signal in the Chip domain; and
generate, said chip domain observation based on said step of differentiating said first correlation function.

6. Radio receiver (Rx) for monitoring distortions of a received radio frequency signal in the Chip domain according to claim 5, wherein said signal processing means (SPM) further, to differentiate said first correlation function to obtain said chip domain observation, is configured to:
calculate a difference between each correlation function point and its former correlation function point both belonging to the first correlation function

7. Radio receiver (Rx) for monitoring distortions of a received radio frequency signal in the Chip domain according to claim 5, wherein said signal processing means (SPM) further, to differentiate said first correlation function to obtain said chip domain observation, is configured to:
offset said replica radio frequency signal of said received radio signal to said received radio frequency signal over one sample period to obtain an offset synchronized replica radio frequency signal;
correlate said received radio frequency signal with said offset synchronized replica radio frequency signal, to generate a second correlation function, said second correlation function comprising a plurality of correlation function points, each correlation function point representing a differently delayed replica radio frequency signal;
differentiate said second correlation function from said first correlation function to generate said chip domain observation.

8. Radio receiver (Rx) for monitoring distortions of a received radio frequency signal in the Chip domain according to claim 5, wherein said signal processing means (SPM) further, to differentiate a first correlation function to obtain said chip domain observation, is configured to:
generate, a second synchronized correlation function by offsetting said first correlation function over one sample period in the correlation sample epoch (domain); and
differentiate said second correlation function from said first correlation function to generate said chip domain observation.

9. Radio frequency System for monitoring distortions of a received (digital) radio frequency signal in the Chip domain at a radio receiver Rx of said radio frequency system, said radio frequency system further comprising a radio transmitter Tx for transmitting a radio frequency signal to said radio receiver, wherein said Radio frequency System comprises a radio receiver according to claim 5.
